(19) United States
(12) Patent Application Publication
(10) Pub. No.: US 2025/0031090 A1
(43) Pub. Date: Jan. 23, 2025

(54) SUPPORT FOR APPLICATION DATA UNIT BASED QUALITY OF SERVICE

(71) Applicant: QUALCOMM Incorporated, San Diego, CA (US)

(72) Inventors: Dario Serafino TONESI, San Diego, CA (US); Miguel GRIOT, La Jolla, CA (US); Prashanth Haridas HANDE, San Diego, CA (US); Haris ZISIMOPOULOS, London (GB); Mickael MONDET, Louannec (FR); Yih-Hao LIN, San Diego, CA (US)

(21) Appl. No.: 18/710,589

(22) PCT Filed: Aug. 15, 2022
(86) PCT No.: PCT/US22/40364

§ 371 Date: May 15, 2024

(30) Foreign Application Priority Data
Jan. 28, 2022 (GR) 20220100085

(51) Int. Cl. H04W 28/02

(52) U.S. Cl. CPC H04W 28/0268; H04W 28/0252

(57) ABSTRACT

Aspects relate to core network entities that: establish a session including at least one of: application data unit (ADU) detection rules, or ADU handling rules related to a detection of ADUs in a user plane, and determine, for one or more quality of service (QOS) flows, whether ADU awareness applies based on an application of the ADU detection rules, or the ADU handling rules; and transmit a request to create a session that supports ADU-based QoS flows, negotiate at least one of: ADU-based QoS policies, or ADU QoS rules applicable to the session, and receive an acknowledgment of creation of the session in response to completing the negotiating. A radio access network entity conveys, during a session, one or more ADUs to a user equipment via a user plane in compliance with ADU-based QoS policies associated with at least one ADU aware QoS flow.

### CROSS-REFERENCE TO RELATED APPLICATIONS

This application for patent claims priority to and the benefit of Greek patent application No. 20220100085 entitled “Support for Application Data Unit Based Quality of Service” filed in the Greek Patent and Trademark Office on Jan. 28, 2022, the entire content of which is incorporated herein by reference as if fully set forth below in its entirety and for all applicable purposes.

### TECHNICAL FIELD

The technology discussed below relates generally to wireless communication networks, and more particularly, to support for application data unit (ADU)-based quality of service (QOS).

### INTRODUCTION

3GPP systems have historically supported a protocol data unit (PDU)-based quality of service (QOS) framework. By way of example, data is gathered into PDUs. Streams of PDUs may form IP flows. IP flows may be filtered and separated into various QoS flows. The QoS flows may be differentiated according to QoS Flow IDs (QFIs), which are used to identify particular QoS flows in a 5G System. User plane traffic with the same QFI within a PDU session receives the same traffic forwarding treatment (e.g., scheduling, admission threshold).

In the future, 3GPP systems may support an application data unit (ADU)-based QoS framework (sometimes referred to as a PDU Set-based QoS framework). An ADU may be a set of PDUs jointly processed by applications. ADUs are comprised of a plurality of PDUs; consequently, different mechanisms may be needed to handle ADUs, or ADUs and PDUs, in any given QoS framework.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a core network entity for wireless communication is disclosed. The core network entity includes a memory and a processor coupled to the memory. In the example, the processor and the memory are configured to establish a session that includes at least one of: application data unit (ADU) detection rules, or ADU handling rules related to a detection of ADUs in a user plane, and to determine, for one or more quality of service (QoS) flows, whether ADU awareness applies based on an application of the at least one of: the ADU detection rules, or the ADU handling rules.

In another example, a method at a core network entity is disclosed. The method includes establishing a session that includes at least one of: application data unit (ADU) detection rules, or ADU handling rules related to a detection of ADUs in a user plane, and determining, for one or more quality of service (QOS) flows, whether ADU awareness applies based on an application of the at least one of: the ADU detection rules, or the ADU handling rules.

According to one aspect, a core network entity for wireless communication is disclosed. The core network entity includes a memory and a processor coupled to the memory. In this aspect, the processor and the memory are configured to transmit a request to create a session that supports application data unit (ADU) based quality of service (QOS) flows, negotiate at least one of: ADU-based QoS policies, or ADU QoS rules applicable to the session, and receive an acknowledgment of creation of the session in response to completing the negotiating.

In another example, a method at a core network entity is disclosed. the method includes transmitting a request to create a session that supports application data unit (ADU) based quality of service (QOS) flows, negotiating at least one of: ADU-based QoS policies, or ADU QOS rules applicable to the session, and receiving an acknowledgment of creation of the session in response to completing the negotiating.

In still another example, a method at a radio access network (RAN) entity is disclosed. The method includes receiving a session request, accepting establishment of the session, transmitting a session response, and conveying, during the session, one or more application data units (ADUs) to a user equipment via a user plane in compliance with ADU-based QoS policies associated with at least one ADU aware QoS flow.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a schematic illustration of a wireless communication system according to some aspects.

FIG. 2 is a schematic illustration of an example of a radio access network according to some aspects.

FIG. 3 is a diagram illustrating an example of a frame structure for use in a radio access network according to some aspects.

FIG. 4 is a block diagram illustrating an example of a 5G wireless communication system according to some aspects.

FIG. 5 is a call flow diagram illustrating a setting up of an application function session with a QoS procedure.

FIG. 6 is a call flow diagram related to user equipment requested packet data unit session establishment according to some aspects.

FIG. 7 is a block diagram illustrating an example of a hardware implementation of a core network entity employing a processing system according to some aspects.

FIG. 8 is a flow chart illustrating an example process of wireless communication at a core network entity according to some aspects.

FIG. 9 is a flow chart illustrating an example process of wireless communication at a core network entity according to some aspects.

FIG. 10 is a flow chart illustrating an example process of wireless communication at a core network entity according to some aspects.

FIG. 11 is a block diagram illustrating an example of a hardware implementation of a radio access network entity employing a processing system according to some aspects.

FIG. 12 is a flow chart illustrating an example process of wireless communication at a RAN entity according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc. of varying sizes, shapes, and constitution.

The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHZ-71 GHZ), FR4 (52.6 GHZ-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

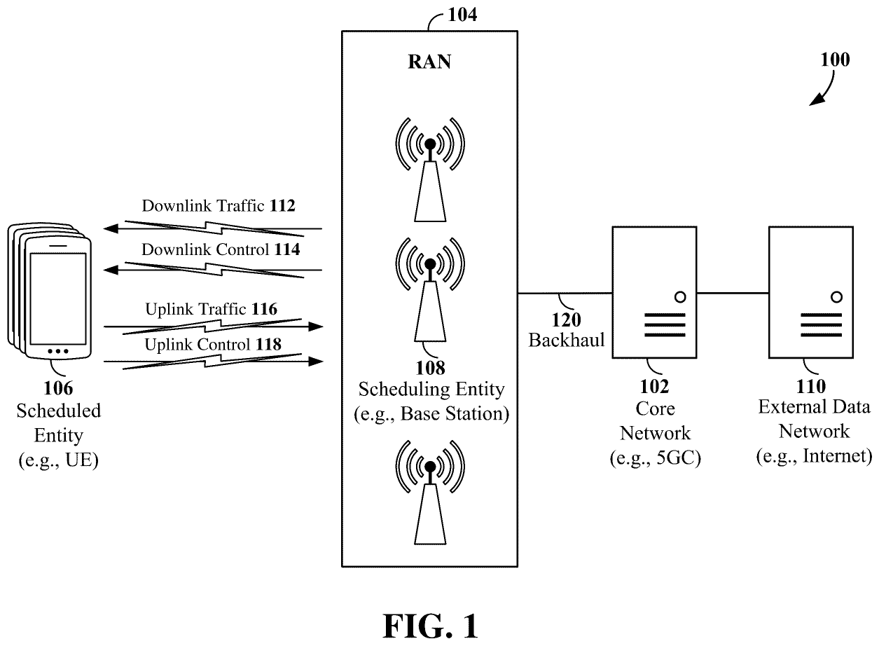

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (cUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (NB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmission. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control information 114 and/or 118 and/or traffic 112 and/or 116 information may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

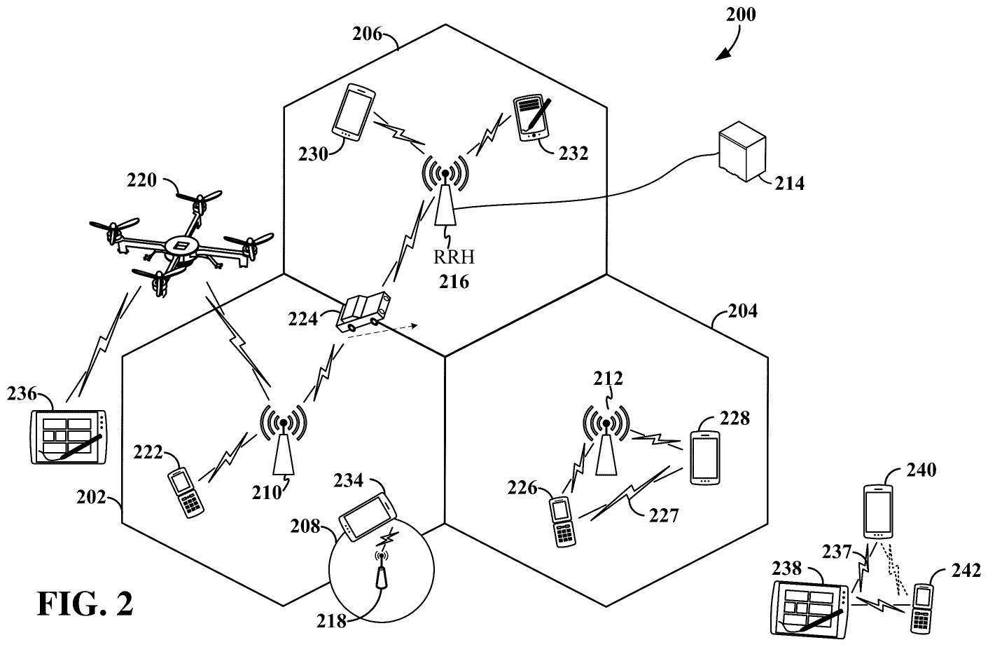

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

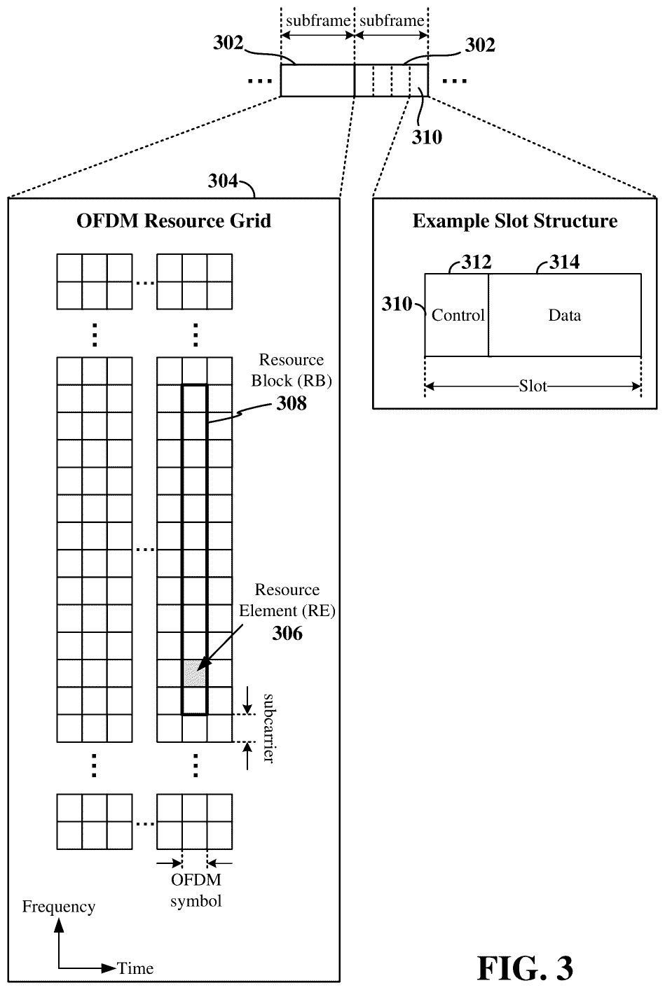

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the physical (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between devices, and those of ordinary skill in the art will recognize that other channels or carriers may be utilized in addition to those illustrated, such as other traffic, control, and feedback channels.

Historically 3GPP systems support a protocol data unit (PDU) based QoS framework. An example of a PDU is an IP packet. A new framework referred to as application data unit (ADU)-based QoS framework (sometimes referred to as a PDU Set-based QoS framework) is currently under consideration in 3GPP. Application data units (ADUs) may be sets of IP packets jointly processed by applications. For example, an ADU or a PDU Set may include one or more PDUs carrying a payload of one unit of information generated at an application level (e.g., a frame or video slice for extended reality mobile (XRM) Services. In some implementations, all PDUs in a ADU or a PDU Set may be needed by the application layer to use the corresponding unit of information. In other implementations, the application layer may still recover all or parts of the information unit, when some PDUs are missing.

As used herein, a “burst” describes a set of ADUs (or PDU Sets) generated by applications at substantially the same time. In other words, a burst (also referred to as a “data burst”) may be a set of data generated and sent by an application in a short period of time. A data burst may include one or multiple ADUs or PDU Sets.

Applications consume data in ADUs. By definition, ADUs are larger than IP packets because ADUs are made up of multiple IP packets. ADU related key performance indicators/ADU QOS parameters include at least ADU Error Rate (AER) and ADU Delay Budget (ADB).

AER defines an acceptable maximum number of ADUs received in error on average. In more detail, the ADU Error Rate (AER) (also referred to as the PDU Set Error Rate (PSER) may be an upper bound for a ratio between a number of ADUs (or PDU Sets) not successfully received and a total number of ADUs (or PDU Sets) sent towards a recipient measured over a measurement window. According to some aspects, the ADU Error Rate can be used by a communication system to set rate adaptation target, number of HARQ retransmission, radio link control (RLC) parameters based on ADU Error Rate rather than on PDU error rate.

ADB defines a maximum delay tolerable for an ADU. In more detail, the ADU Delay Budget (ADB) (also referred to as a PDU Set Delay Budget (PSDB)) may define an upper bound for the time that an ADU (or a PDU Set) may be delayed between the UE and the N6 termination point at the UPF before being considered as not successfully delivered. The ADU Delay Budget may apply to DL ADUs (or DL PDU Sets) received by the UPF over the N6 interface and may represent a difference between the time when the last bit of the last PDU of the ADU (or PDU Set) is injected into the UPF and the time when the last bit of the last PDU of the ADU (or PDU Set) is delivered to the UE. For UL, the ADU Delay Budget applies to the UL ADUs (or PDU Sets) sent by the UE and represents a difference between the time when the last bit of the last PDU of the ADU (or PDU Set) is sent by the UE and the time when the last bit of the last PDU of the ADU (or PDU Set) is delivered to the UPF. This may imply that the time by which all PDUs in the ADU (or PDU Set) have to be received by the UE (for DL) and by the UPF (for UL) is determined when the last PDU of the ADU (or PDU Set) is received at the RAN.

An additional ADU QoS parameter may include maximum ADU size (also referred to as PDU Set Maximum Size ((PSMS). According to some aspects, the maximum ADU size may be expressed in bytes. The maximum ADU size may indicate to a RAN scheduler an upper bound on how many bytes can be scheduled within a certain delay budget.

Aspects described herein may consider how to configure the 5G core network (5G CN), the 5G AN (Access Network) and the UE to use the ADU-based QoS framework.

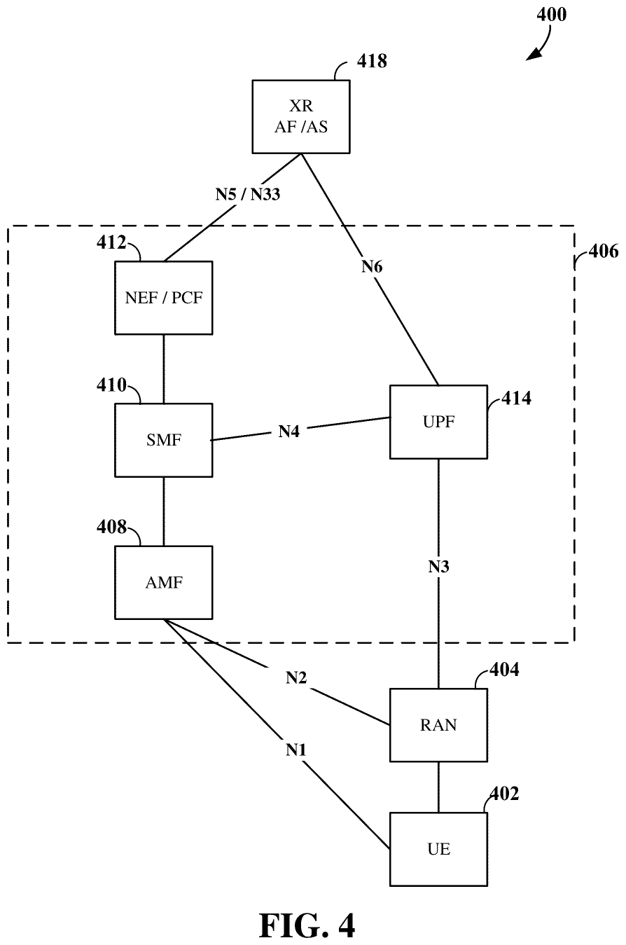

Referring now to FIG. 4, by way of example and without limitation, a block diagram illustrating an example of various components of a 5G wireless communication system (5GS) 400 is provided. In some examples, the 5GS 400 may correspond to the wireless communication system 100 described above and illustrated in FIG. 1. The 5GS 400 includes a user equipment (UE) 402, a RAN entity 404 (e.g., a 5G AN), and a core network 406 (e.g., a 5G CN). The RAN entity 404 may be a 5G RAN and correspond, for example, to the RAN 200 described above and illustrated in FIG. 2. In addition, the UE 402 may correspond to any of the UEs or other scheduled entities shown in FIGS. 1 and/or 2. By virtue of the wireless communication system 400, the UE 402 may be enabled to carry out data communication with an extended reality application function (XR AF) or an extended reality application server (XR AS), collectively identified as XR AF/AS 418. Of course, the UE 402 may be enabled to carry out data communication with any external data network (not shown), such as, but not limited to, the Internet or an Ethernet network. According to aspects herein, if application data unit (ADU) awareness is configured in uplink, the UE 402 may be configured with ADU aware uplink filters. The ADU aware uplink filters may be configured to the UE 402 by a session management function (SMF) 410 in protocol data unit (PDU) session establishment or PDU session modification.

In addition to the SMF 410, the core network 406 may include, for example, an access and mobility management function (AMF) 408 and a user plane function (UPF) 414. The AMF 408 and SMF 410 may employ control plane (e.g., non-access stratum (NAS)) signaling to perform various functions related to mobility management and session management for the UE 402. For example, the AMF 408 may provide connectivity, mobility management, and authentication of the UE 402, while the SMF 410 may provide session management (SM) of the UE 402. Session management may include, for example, the processing of signaling related to PDU sessions between the UE 402 and the XR AF/AS 418 (or an external data network (not shown)). More specifically, the SMF 410 may determine ADU 5G QoS flow identifier (A5Q1) and ADU aware QoS flows. Additionally, the SMF 410 may configure the UPF 414 with ADU aware filters and/or ADU detection rules. The UPF 414 may provide user plane connectivity to route 5G NR packets to/from the UE 402 via the RAN entity 404. The RAN entity 404 may engage in ADU aware scheduling. Still further, the SMF 410 may configure the RAN 404 with ADU aware QoS flows and A5QI, which may include ADU Error Rate (AER) and/or ADU delay budget (ADB) values.

The core network 406 may further include other functions, such as a network exposure function (NEF) and a policy control function (PCF), depicted in one NEF/PCF 412 block for convenience. The NEF of the NEF/PCF 412 block may facilitate secure, robust access to exposed network services and capabilities. Accordingly, the NEF may provide secure provision of information from external applications to a 3GPP network. The PCF of the NEF/PCF 412 block may provide policy rules for control plane functions. This may include network slicing, roaming, and mobility management. In aspects related to the disclosure, the PCF may provide policies for ADU-based QoS. The PCF also supports 5G QoS policy and charging control functions.

Various interfaces are depicted in FIG. 4. For example, the N6 interface between the XR AF/AS 418 and the UPF 414 is a user plane interface. The N5/N33 interfaces between the XR AF/AS 418 and the NEF/PCF 412 may be provided for application negotiation (via the NEF/PCF 412).

To establish a connection to the core network 406 (e.g., a 5G core network) via the RAN entity 404, the UE 402 may transmit a registration request to the AMF 408 of the core network 406 via the RAN entity 404. The AMF 408 may then initiate non access stratum (NAS) level authentication between the UE 402 and the core network (e.g., via an AUSF and UDM (not shown)). The AMF 408 may then retrieve mobility subscription data, SMF 410 selection data, and UE 402 context and communicate with the NEF/PCF 412 for policy association for the UE 402. The AMF 408 may then send a NAS secure registration accept message to the UE 402 to complete the registration.

Once the UE 402 has registered with the core network 406, the UE 402 may transmit a PDU session establishment request to establish one or more PDU sessions to the core network 406 via the RAN entity 404. The AMF 408 and SMF 410 may process the PDU session establishment request and establish a data network session (DNS) between the UE 402 and the XR AF/AS 418 via the UPF 414 and an application data unit processing layer (not shown), for example. A DNS may include one or more sessions (e.g., data sessions or data flows) and may be served by multiple UPFs 414 (only one of which is shown for convenience). Examples of data flows include, but are not limited to, IP flows, Ethernet flows and unstructured data flows.

The core network 406 may include functions in addition to those described above. The additional functions include, but are not limited to, an authentication server function (AUSF), a unified data management (UDM) entity, a network slice selection function (NSSF), a network repository function (NRF), etc. As these functions are known to those of ordinary skill in the art, they will not be described further, and are not illustrated, for the sake of simplicity.

In order to configure the 5G CN (e.g., core network 406), 5G AN (e.g., RAN 404), and UE 402 to use the ADU-based QoS framework, new QoS information and control plane signaling may be defined. With regard to the new QoS information, new and standardized A5QI values may be utilized. The new and standardized values exemplified in the present disclosure include ADU error rate and ADU delay budget. With regard to the control plane signaling, a new negotiation between an application function (AF) and a 5GS may be defined. More particularly, the negotiation between the AF and 5GS may involve negotiations concerning ADU-based QoS levels and ADU marking (also known as PDU Set marking or burst marking) (e.g., marking to identify ADUs in IP, real time-transport protocol (RTP), and other protocols). According to one aspect, the SMF 410 may determine that ADU-based QoS is needed. The SMF 410 may configure the UPF 414 and RAN 404 to support the ADU-based QoS. The SMF 410 may undertake session management (SM) negotiation with the UE 402 to implement the ADU-based QoS. According to one aspect, the SM negotiations with the UE 402 may be accomplished by modifying (e.g., extending) a current PDU establishment and/or PDU modification process.

Currently, 5GS relies on a PDU-based QoS framework, and as such, there is no concept of an ADU-based QoS framework in present 5GS specifications. The PDU-based QoS framework defines the following concepts:
(1) QoS profile, which describes the characteristics of a QoS flow; and
(2) 5G QoS flow identifier (5Q1), which identifies a specific QoS flow.

According to aspects described herein, the ADU-based QoS framework may be based on:
(1) detection of ADUs in the user plane, where the detection is performed in the 5G core network;
(2) introduction of new policies for ADUs; and
(3) control of the ADU-based QoS by the SMF.

In one example, to implement the ADU-based QoS framework, a new type of QoS profile may be defined. The new type of QoS profile may specifically support the ADU QoS framework; in other words, it may not include definitions of QoS information that are not related to the ADU QoS framework. According to a second example, an existing QoS profile may be extended to cover QoS aspects of both the existing PDU-based QoS framework and the new ADU-based QoS framework.

QoS Profile 1, below, depicts an existing QoS profile according to the PDU-based QoS framework. QoS Profile 2, below, depicts a new QoS profile according to the ADU-based QoS framework. The following terms are abbreviated as shown: Allocation and Retention Priority (ARP); Reflective QoS Attribute (RQA); Guaranteed Flow Bit Rate (GFBR); Maximum Flow Bit Rate (MFBR); and Guaranteed Bit Rate (GBR).

QoS Profile 1
(Existing PDU-based QoS Profile)

| | |
|---|---|
| QoS Flow Type | QoS Flow Parameters |

| | | |
|---|---|---|
| GBR Flow | Non-GBR Flow | 5QI |
| | | ARP |
| | | RQA |
| | | GFBR |
| | | MFBR |
| | | Notification Control |
| | | Maximum Packet Loss Rate |

QoS Profile 2
(New ADU-based QoS Profile)

| QoS Flow Type | QoS Flow Parameters |
|---|---|
| Not Applicable | A5QI |
| | Max ADU Size |
| | Max # PDUs/ADU |

Table 1, below, is an excerpt from an existing standardized table of 5QI values. The source of the excerpt is 3GPP TS 23.501, version 17.3.0, dated December 2021, section 5.7.4. Table 2, below, is an example of a portion of a new standardized table of A5QI values.

TABLE 1
Existing Standardized 5QI Values (PDU-based QoS Framework)

| | | | | | Default | | |
|---|---|---|---|---|---|---|---|
| | | | | | Max | | |
| | | Default | PDU | PDU | Data | Default | |
| 5QI | Resource | Priority | Delay | Error | Burst | Averaging | Example |
| Value | Type | level | Budget | Rate | Value | Window | Services |
| 1 | GBR/ | 20 | 100 ms | 10⁻² | N/A | 2000 ms | Conversational |
| | Non- | | | | | | Voice |
| | GBR/ | | | | | | |
| | Delay | | | | | | |
| | Critical | | | | | | |
| | GBR | | | | | | |

TABLE 2
New Standardized A5QI Values (ADU-based QoS Framework)

| | | | | | Default | | |
|---|---|---|---|---|---|---|---|
| | | | | | Max | | |
| | | Default | ADU | ADU | Data | Default | |
| A5QI | Resource | Priority | Delay | Error | Burst | Averaging | Example |
| Value | Type | level | Budget | Rate | Value | Window | Services |
| 99 | Delay | 20 | 100 ms | 10⁻² | N/A | 2000 ms | Visual content |
| | Critical | | | | | | for |
| | GBR | | | | | | cloud/edge/ |
| | | | | | | | split rendering |
| | | | | | | | for XRM |
| | | | | | | | services |

QoS Profile 2 may be used in parallel with QoS Profile 1. Each row of the new ADU-based QoS Profile 2 includes an A5QI, an ADU delay budget (ADB) value, and an ADU error rate (AER) value.

In another example, QoS Profile 1 may be modified (as shown in QoS Profile 3, below) to include an indication (e.g., a flag) of whether the QoS profile applies to ADU-based QoS (in addition to PDU-based QoS), an indication of the ADU Delay Budget, and an indication of AER. Similarly, the standardized tables for 5QI and A5QI may be merged to create a new table that includes information related to both 5QI and A5QI (i.e., both PDU-based QoS and ADU-based QoS), as shown below in Table 3.

QoS Profile 3
(Modified PDU-based QoS Profile)

| | |
|---|---|
| QoS Flow Type | QoS Flow Parameters |

| | | |
|---|---|---|
| GBR Flow | Non-GBR Flow | 5QI |
| | | ARP |
| | | RQA |
| | | GFBR |
| | | MFBR |
| | | Notification Control |
| | | Maximum Packet Loss Rate |

QoS Profile Supports ADU QoS [Yes/No]
Max ADU Size
Max # of PDUs per ADU

TABLE 3
Modified Original Standardized with A5QI Values (ADU-based QoS Framework)

| | | | | | | | | | | |
|---|---|---|---|---|---|---|---|---|---|---|
| | | | | | | | | ADU | | |
| | | | | | Default | | | Default | | |
| | | | | | Max | | | Max | | |
| | | Default | Packet | Packet | Data | ADU | ADU | Data | Default | |
| A5QI | Resource | Priority | Delay | Error | Burst | Delay | Error | Burst | Avg'g | Example |
| Value | Type | level | Budget | Rate | Value | Budget | Rate | Volume | Window | Services |

| | | | | | | | |
|---|---|---|---|---|---|---|---|
| 99 | Delay | 20 | 100 ms | 10⁻² | N/A | 2000 ms | Visual |
| | Critical | | | | | | content for |
| | GBR | | | | | | cloud/edge/ |
| | | | | | | | split |
| | | | | | | | rendering |
| | | | | | | | for XRM |
| | | | | | | | services |

With regard to control plane signaling modifications to support ADU-based QoS, according to aspects described herein, control plane signaling may be changed to support application function (AF)/5GS negotiation with respect to the practice of ADU-based Qos and ADU marking (e.g., in IP, RTP, and other protocols).

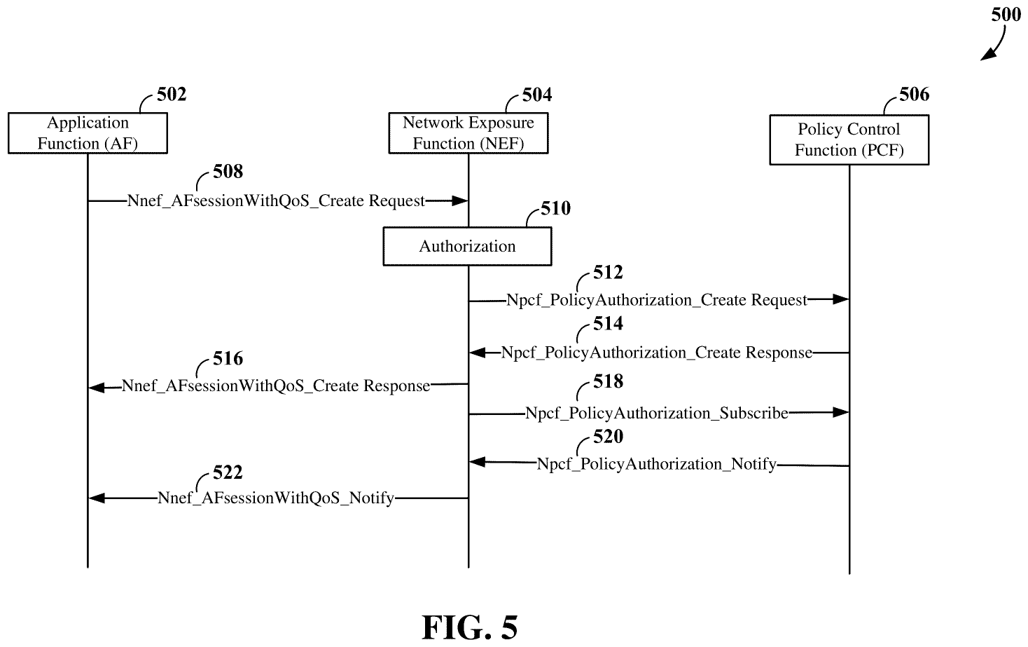

FIG. 5 is a call flow diagram 500 depicting an example of establishing an application function session with a QoS procedure. An application function (AF) 502, a network exposure function (NEF) 504, and a policy control function (PCF) 506 are depicted. At 508, the AF 502 may send a request to reserve resources for an AF session, by sending a Nnef_AFsessionWithQoS_Create request message, to the NEF 504. The content of the Nnef_AFsessionWithQoS_Create request message constitutes an initiation of a negotiation between the AF 502 and a 5G wireless communication system (5GS) (via the PCF 506). Using the Nnef_AFsessionWithQoS_Create request message, the AF 502 effectively asks the PCF 506 if the 5GS supports ADU-based QoS. The response of the 5GS via the PCF 506 may indicate whether ADU-based or PDU-based QoS is supported.

According to one aspect, the Nnef_AFsessionWithQoS_Create request message may include a UE address, an AF Identifier, a flow description(s), or External Application Identifier, a QoS reference, and may further include Alternative Service Requirements. In some examples, a period of time or a traffic volume for the requested QoS may be included in the Nnef_AFsessionWithQoS_Create request message. According to some aspects, instead of a QoS Reference, the AF 502 may provide the following individual QoS parameters: Requested 5GS delay (optional), Requested Priority (optional), Requested Guaranteed Flow bit rate (GFBR), Requested Maximum Flow bit rate (MFBR), flow direction, Burst Size (optional), Burst Arrival Time (optional) at UE (uplink) or UPF (downlink), periodicity (optional), time domain (optional), and/or Survival Time (optional). When Alternative Service Requirements are provided by the AF 502, a set of Alternative QOS Related parameters in the form of an Alternative QoS profile may be provided for each QOS Reference. Accordingly, there may be one or more ways to indicate a request for support of ADU-based QoS. For example, an Alternative QoS profile, such as QoS Profile 2 or QoS Profile 3, shown above (both of which include QoS flow parameters that may be representative of an ADU-based QoS), may be conveyed to the PCF 506.

At 510, during authorization, the NEF 504 may assign a Transaction Reference ID to the Nnef_AFsessionWithQoS_Create request message sent at 508. At 510, the NEF 504 may authorize the AF request and may apply policies to control the overall amount of QoS authorized for the AF 502. If, at 510, the Nnef_AFsessionWithQoS_Create request message is not authorized, or the requested/required QoS is not allowed, the actions at 512, 514, 518, 520, and 522 may be skipped and, at 516, the NEF 504 may respond to the AF 502 using a Nnef_AFsessionWithQoS_Create response message, which may include the Transaction Reference ID and a result value. In such a case, the result value may indicate that the authorization at 510 failed. The result value may indicate a failure cause.

If the NEF 504 does not receive any of the individual QoS parameters (e.g., a specific QoS, such as low latency, or jitter, or a QoS based on specific service requirements) from the AF 502, the NEF 504 may use the UE address (provided with the Nnef_AFsessionWithQoS_Create request message) to discover the PCF 506 from a building support function (BSF) (not shown). At 512, the NEF 504 may interact with the PCF 506 by sending a Npcf_PolicyAuthorization_Create request message to the PCF 506. The NEF 504 may provide the UE address, AF Identifier, flow description(s), the QoS Reference, and the Alternative Service Requirements (if included) (provided with the Nnef_AFsessionWithQoS_Create request message) to the PCF 506 with the Npcf_PolicyAuthorization_Create request message. Any received period of time or traffic volume may also be included and mapped to sponsored data connectivity information. At 514, the PCF 506 may respond with a Npcf_PolicyAuthorization_Create response. At 518, the NEF 504 may also send a Npcf_PolicyAuthorization_Subscribe message and may receive, in response, at 520, a Npcf_PolicyAuthorization_Notify message from the PCF 506. Alternative steps (not shown) may be executed.

If the AF 502 is considered to be trusted by the operator, the AF 502 may use the Npcf_PolicyAuthorization_Create request message, at 512, to interact directly with PCF 506 to request reserving resources for an AF session. If the AF 502 is considered to be trusted by the operator, the PCF 506, at 514, may send the Npcf_PolicyAuthorization_Create response message directly to AF 502 (not shown).

The PCF 506 may determine whether the Npcf_PolicyAuthorization_Create request message, of 512, is authorized and may, at 514, notify the NEF 504 if the request is not authorized via an Npcf_PolicyAuthorization_Create response message.

If the Npcf_PolicyAuthorization_Create request message, at 512, is authorized, the PCF 506 may derive the required QoS parameters based on the information provided by the NEF 504 and may determine whether this QOS (i.e., the requested QoS) is allowed (according to the PCF configuration). The PCF 506, at 514, may notify the result to the NEF 504 via the Npcf_PolicyAuthorization_Create response message. In addition, if the Alternative Service Requirements are provided, the PCF 506 may derive the Alternative QoS parameter set(s) from the one or more QoS reference parameters contained in the Alternative Service Requirements in the same prioritized order.

In some examples, the PCF derived Alternative QoS parameter set(s) for the policy and charging control (PCC) rule may be subsequently used to establish Alternative Qos Profile(s). The Alternative QoS Profile parameters provided to an NG-RAN (not shown) may be specified elsewhere. If the PCF 506 determines that the SMF (not shown) needs updated policy information, the PCF 506 may issue a Npcf_SMPolicyControl_UpdateNotify request message (not shown) with updated policy information about the PDU Session. The Npcf_SMPolicyControl_UpdateNotify request message may be sent during a PCF 506 initiated SM Policy Association Modification procedure (which is not shown and is not described herein).

At 518, the NEF 504 may send a Npcf_PolicyAuthorization_Subscribe message to the PCF 506 to subscribe to notifications of Resource allocation status and may subscribe to other events not described herein.

At 520, upon meeting the event condition, e.g., the success or failure of the establishment of the transmission resources corresponding to the QoS update, the PCF 506 may send a Npcf_PolicyAuthorization_Notify message to the NEF 504 notifying the NEF 504 about the event.

If the AF 502 is considered to be trusted by the operator, the PCF 506 may send the Npcf_PolicyAuthorization_Notify message directly to AF 502 (not shown).

At 522, the NEF 504 may send a Nnef_AFsessionWithQoS_Notify message with the event reported by the PCF 506 to the AF 502.

The AF 502 may send a Nnef_AFsessionWithQoS_Revoke request message (not shown) to the NEF 504 to revoke the AF request. The NEF 504 may authorize the revoke request and may trigger a Ntsctsf_QoSandTSCAssistance_Delete/Unsubscribe and/or Npcf_PolicyAuthorization_Delete and the Npcf_PolicyAuthorization_Unsubscribe operation in response to the Nnef_AFsessionWithQoS_Revoke request message (not shown).

The call flow diagram 500 and the process described therein may be modified as needed so that the AF 502 and 5GS, via the PCF 506, may negotiate the capability of supporting ADU-based QoS (e.g., in short, the AF 502 asks the 5GS if the 5GS supports ADU-based QoS and the 5GS replies accordingly). The AF 502 and 5GS, via the PCF 506, may negotiate how to identify the ADU over the user plane (e.g., IP based, RTP based approach, etc.). The AF 502 may require ADU-based QoS requirements (e.g., as provided in an extension of QoS Reference or in new QoS parameters) and the 5GS, via the PCF 506, may set up policies/rules accordingly.

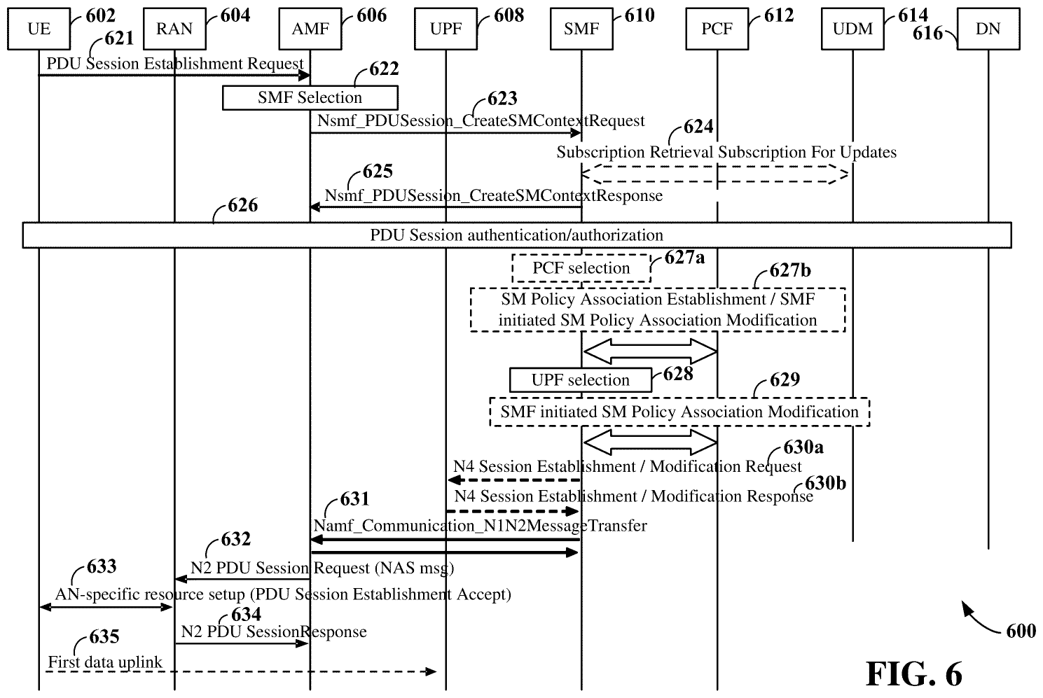

FIG. 6 is a call flow diagram 600 related to UE requested PDU session establishment according to some aspects. Specifically, the call flow diagram 600 relates to PDU session establishment in non-roaming and roaming with local breakout cases. The procedure may be used, for example, to establish a new PDU session, handover a packet data network (PDN) connection in an Evolved Packet System (EPS) to PDU session in 5GS without an N26 interface (not shown), switch an existing PDU session between non-3GPP access and 3GPP access, or request a PDU session for emergency services. An N26 interface may be an interface which interconnects the AMF 408 with 4G network node MME (not shown) and enables interworking between 5G to 4G and vice versa. A UE 602, RAN 604, AMF 606, UPF 608, SMF 610, PCF 612, UDM 614, and data network (DN) 616 are depicted. The procedure depicted in FIG. 6 assumes that the UE 602 has already registered on the AMF 606, thus unless the UE 602 is Emergency Registered, the AMF 606 has already retrieved the user subscription data from the UDM 614.

At 621, the UE 602 may send a NAS Message including a PDU Session Establishment Request to the AMF 606. In order to establish a new PDU Session, the UE generates a new PDU Session ID which is inserted into the NAS message. The UE initiates a UE Requested PDU Session Establishment procedure by the transmission of the NAS message including the PDU Session Establishment Request within an N1 session management (SM) container. The PDU Session Establishment Request includes a PDU session ID, Requested PDU Session Type, a requested session and service continuity (SSC) mode, 5GSM Capability, Protocol Configuration Options (PCO), SM PDU DN Request Container, [Number of Packet Filters], [Header Compression Configuration], UE Integrity Protection Maximum Data Rate, [Always-on PDU Session Requested], [Redundancy Steering Number (RSN)] and [PDU Session Pair ID]. The Number of Packet Filters indicates the number of supported packet filters for signaled QoS rules for the PDU Session that is being established. The Number of Packet Filters indicated by the UE is valid for the lifetime of the PDU Session.

At 622, the AMF 606 may select an SMF 610.

At 623, the AMF 606 may send to the SMF 610 either a Nsmf_PDUSession_CreateSMContext (or an Nsmf_PDUSession_UpdateSMContext Request (not shown)).

At 624, subscription information may be retrieved and/or updated.

At 625, the SMF 610 may send to the AMF 606 either a Nsmf_PDU Session_CreateSMContext Response or an Nsmf_PDUSession_UpdateSMContext Response (not shown) depending on the request received in at 623.

At 626, secondary authentication/authorization may be conducted.

At 627a, if dynamic PCC is to be used for the PDU Session, the SMF 610 may perform PCF 612 selection. If the Request Type indicates “Existing PDU Session” or “Existing Emergency PDU Session,” the SMF 610 may use the PCF 612 already selected for the PDU Session. Otherwise, the SMF 610 may apply local policy.

At 627b, the SMF 610 may perform an SM Policy Association Establishment procedure or an SMF initiated SM Policy Association Modification. According to aspects described herein, the Policy Charging and Control (PCC) Rules provided by the PCF 612 may be updated to receive ADU-based QoS policies and to select a UPF 608 that supports the ADU-based QoS framework. According to one aspect, the update to the policy rules provided by the PCF 612 may be applicable to dynamic PCC rules.

At 628, the SMF 610 may select one or more UPFs 608 as needed. Additionally, PDU Session establishment and/or PDU Session modification may provide for ADU (or PDU Set) detection rules to be send to the UPF.

At 629, the SMF 610 may perform an SMF 610 initiated session management (SM) Policy Association Modification procedure.

If a Request Type indicates “initial request,” the SMF 610 may initiate an N4 Session Establishment procedure with the selected UPF(s) 608, otherwise the SMF 610 may initiate an N4 Session Modification procedure with the selected UPF(s) 608. The N4 Session Establishment/Modification Request/Response may include Packet Detection Rules. In accordance with some aspects described herein, these packet detection rules may be configured to optionally support ADU detection rules.

At 630a, the SMF 610 may send an N4 Session Establishment/Modification Request to the UPF 608. If SMF 610 decides to perform redundant transmission for one or more QoS Flows of the PDU session, two CN Tunnel Info are requested by the SMF 610 from the UPF 608. The SMF 610 also indicates the UPF 608 to eliminate the duplicated packet for the QoS Flow in the uplink direction. The SMF 610 indicates the UPF 608 that one CN Tunnel Info is used as the redundancy tunnel of the PDU session. If SMF 610 decides to insert two intermediate-UPFs (I-UPFs) between the PSA UPF and the NG-RAN (e.g., RAN 604) for redundant transmission, the SMF 610 may request the corresponding CN Tunnel Info and provides them to the I-UPFs and PSA UPF respectively. The SMF 610 may also indicate the PSA UPF to eliminate the duplicated packet for the QoS Flow in uplink direction.

At 630b, the UPF 608 may acknowledge by sending an N4 Session Establishment/Modification Response.

At 631, the SMF 610 may send an Namf_Communication_N1N2MessageTransfer to the AMF 606. The Namf_Communication_N1N2MessageTransfer may include N2 SM information, which may include, among other parameters, QoS flow ID(s), QFI(s), and QoS profile(s). According to some aspects, these QFI(s) and QoS profile(s) may be configured to be consistent with ADU-based QoS. Additionally, the Namf_Communication_N1N2MessageTransfer includes an N1 SM container, which may include a PDU Session Establishment Accept message, which may include QoS Rule(s) and QoS Flow level QoS parameters if needed for the QoS Flow(s) associated with the QoS rule(s), among other parameters. These QoS Rule(s) and QoS Flow level QoS parameters, if needed for the QoS Flow(s) associated with the QoS rule(s), may all be configured to be consistent with ADU-based QoS.

Moreover, the N2 SM information carries information that the AMF 606 forwards to the RAN 604, which includes, among other things, one or multiple QoS profiles and the corresponding QFIs that may be provided to the RAN 604. Additionally, PDU Session establishment and/or PDU Session modification may provide for new QoS profiles to be sent the RAN 604. The SMF 610 may indicate for each QoS Flow whether redundant transmission shall be performed by a corresponding redundant transmission indicator. Multiple QOS Rules, QOS Flow level QoS parameters, if needed for the QoS Flow(s) associated with those QoS rule(s) and QoS profiles, may be included in the PDU Session Establishment Accept within the N1 SM and in the N2 SM information.

At 632, the AMF 606 may send an N2 PDU Session Request (NAS message) to the RAN 604.

At 633, the RAN 604 may issue AN specific signaling exchange with the UE 602 related to the information received from the SMF 610. For example, in the case of a NG-RAN, a radio resource control (RRC) Connection Reconfiguration may take place with the UE establishing the necessary NG-RAN resources related to the QoS Rules for the PDU Session request received at 632.

At 634, the RAN may send an N2 PDU Session Response to the AMF 606. The N2 PDU Session Response may include, among other things, a list of accepted/rejected QFI(s). The RAN 604 may reject the addition or modification of a QoS Flow, e.g., due to handling of the UE-Slice-MBR. If the RAN 604 rejects QFI(s), the SMF 610 is responsible for updating the QoS rules and QoS Flow level QoS parameters associated with the rejected QoS Flow(s) in the UE 602, accordingly.

Following a first data uplink at 635, the AMF 606 may forward the N2 SM information received from the RAN 604 to the SMF 610 (not shown). If the list of rejected QFI(s) is included in N2 SM information, the SMF 610 may release the rejected QFI(s) associated QoS profiles.

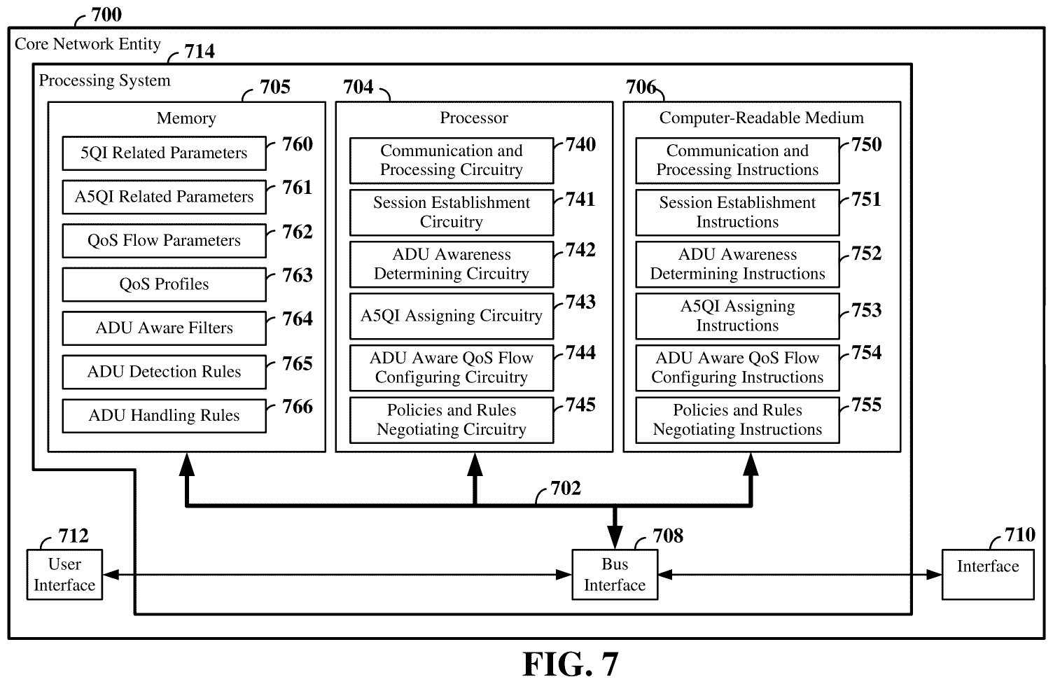

FIG. 7 is a block diagram illustrating an example of a hardware implementation of a core network entity 700 (e.g., an SMF, an AF) employing a processing system 714 according to some aspects. For example, the core network entity 700 may correspond to the SMF 410 or the XR AF/AS 418, as shown and described in connection with FIG. 4.

In accordance with various aspects of the disclosure, an element, or any portion of an element, or any combination of elements may be implemented with a processing system 714 that includes one or more processors, such as processor 704. Examples of processor 704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the core network entity 700 may be configured to perform any one or more of the functions described herein. That is, the processor 704, as utilized in the core network entity 700, may be used to implement any one or more of the methods or processes described and illustrated, for example, in FIGS. 5 and/or 6.

The processor 704 may in some instances be implemented via a baseband or modem chip and in other implementations, the processor 704 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including radio frequency (RF)-chains, power amplifiers, modulators, buffers, interleavers, adders/summers, etc.

In this example, the processing system 714 may be implemented with a bus architecture, represented generally by the bus 702. The bus 702 may include any number of interconnecting buses and bridges depending on the specific application of the processing system 714 and the overall design constraints. The bus 702 links together various circuits, including one or more processors (represented generally by the processor 704), a memory 705, and computer-readable media (represented generally by the computer-readable medium 706). The bus 702 may also link various other circuits such as timing sources, peripherals, voltage regulators, and power management circuits, which are well known in the art and will not be described any further.

A bus interface 708 provides an interface between the bus 702 and an interface 710. The interface 710 may provide a communication interface or a means for communicating with various other apparatus over a transmission medium (e.g., air interface, wired interface). Depending upon the nature of the apparatus, a user interface 712 (e.g., keypad, display, touch screen, speaker, microphone, control knobs, etc.) may also be provided. Of course, such a user interface 712 is optional, and may be omitted in some examples.

The processor 704 is responsible for managing the bus 702 and general processing, including the execution of software stored on the computer-readable medium 706. The software, when executed by the processor 704, causes the processing system 714 to perform the various functions described below for any particular apparatus. The computer-readable medium 706 and the memory 705 may also be used for storing data that is manipulated by the processor 704 when executing software. For example, the memory 705 may store 5G QoS flow identifier (5Q1) related parameters 760, ADU 5G QOS flow identifier (A5QI) related parameters 761, QoS flow parameters 762, QoS profiles 763, ADU aware filters 764, ADU detection rules 765, and/or ADU handling rules 766. The preceding list is exemplary and non-limiting.

One or more processors 704 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 706.

The computer-readable medium 706 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 706 may reside in the processing system 714, external to the processing system 714, or distributed across multiple entities including the processing system 714. The computer-readable medium 706 may be embodied in a computer program product. By way of example, a computer program product may include a computer-readable medium in packaging materials. In some examples, the computer-readable medium 706 may be part of the memory 705. Those skilled in the art will recognize how best to implement the described functionality presented throughout this disclosure depending on the particular application and the overall design constraints imposed on the overall system. In some examples, the computer-readable medium 706 may be implemented on an article of manufacture, which may further include one or more other elements or circuits, such as the processor 704 and/or memory 705.

In some aspects, the core network entity 700 may include a memory, and a processor coupled to the memory, the processor (e.g., the processing system 714, processor 704) and the memory 705 being configured to perform any of the methods, functions, or algorithms described herein. In some aspects of the disclosure, the processor 704 may include circuitry configured for various functions. For example, the processor 704 may include communication and processing circuitry 740, configured to communicate with other core entities via interfaces therebetween. For example, in the case where the core network entity 700 is an SMF, the SMF may communicate with a UPF via an N4 interfaces as shown and described in connection with FIG. 4.

According to some aspects, the communication and processing circuitry 740 may also obtain policy rules related to ADU-based QoS policies from at least one of: a policy control function (PCF), or a local configuration (e.g., in a case in which the policies are configured in an SMF). The communication and processing circuitry 740 may also be configured to: obtain an identity of a user plane function that supports ADU-based QoS policies from a policy control function (PCF).

In some examples, the communication and processing circuitry 740 may include one or more hardware components that provide the physical structure that performs processes related to communication (e.g., signal reception and/or signal transmission) and signal processing (e.g., processing a received signal and/or processing a signal for transmission). For example, the communication and processing circuitry 740 may include one or more modems. In some examples, the communication and processing circuitry 740 may include one or more hardware components that provide the physical structure that performs processes related to processing, such as, for example, obtaining policy rules related to ADU-based QoS policies from at least one of: a policy control function (PCF), or a local configuration, and/or obtaining an identity of a user plane function that supports ADU-based QoS policies from a policy control function (PCF). In some implementations where the communication involves receiving information, the communication and processing circuitry 740 may obtain information from a component of the core network entity 700 (e.g., from the interface 710 that receives the information via a hardwired or wireless operational coupling to, for example, a data network (not shown), process the information, and output the processed information. For example, the communication and processing circuitry 740 may output the information to another component of the processor 704, to the memory 705, or to the bus interface 708. In some examples, the communication and processing circuitry 740 may receive one or more of signals, messages, other information, or any combination thereof. In some examples, the communication and processing circuitry 740 may include functionality for a means for receiving.

In some aspects of the disclosure, the processor 704 may include session establishment circuitry 741 configured for various functions, including, for example, establishing a session that includes at least one of: application data unit (ADU) detection rules, or ADU handling rules related to a detection of ADUs in a user plane. The session may be, for example, a PDU session. In some examples, the core network entity may be a session management function (SMF), and the session may be established with a user plane function (UPF) over an interface between the SMF and the UPF. The interface may be, for example, an N4 interface. The session establishment circuitry 741 may also configure ADU aware uplink filters to a user equipment during at least one of: PDU session establishment, or PDU session modification. ADU aware filters may be stored, for example, in an ADU aware filters 764 portion of the memory 705 according to some examples. By way of example, an ADU may be comprised of a set of Internet Protocol (IP) packets or Ethernet frames (but not a combination of the two) jointly processed by at least one of: an application function, or an application server. One or more ADUs, each comprising a plurality of PDUs, may be: generated by an application server at substantially a same time, and may be grouped in at least one burst. In examples where the core network entity 700 is an application function (AF), the session establishment circuitry 741 may further be configured, for example, to transmit a request to create a session that supports ADU-based QoS flows. In some examples, when the core network entity 700 is an application function (AF), the session may be an AF session. Still further, in examples where the core network entity 700 is an application function (AF), a request to create the session may be transmitted to a network exposure function (NEF) and the acknowledgment may be received from the NEF if the core network entity is not a trusted core network entity, or the request to create the session may be transmitted to a policy control function (PCF) and the acknowledgment may be received from the PCF if the core network entity is a trusted core network entity.

In some examples, the session establishment circuitry 741 may include one or more hardware components that provide the physical structure that performs processes related to establishing a session that includes at least one of: ADU detection rules, or ADU handling rules related to a detection of ADUs in a user plane, and/or, for examples where the core network entity may be an SMF, establishing a session with a UPF over an interface, such as an N4 interface, between the SMF and the UPF, and/or transmitting a request to create a session that supports ADU-based QoS flows. The session establishment circuitry 741 and/or the communication and processing circuitry 740, may receive an acknowledgment of creation of the session in response to completing a negotiation. The session establishment circuitry 741 may further be configured to execute session establishment instructions 751 (e.g., software) stored on the computer-readable medium 706 to implement one or more functions described herein.

In some aspects of the disclosure, the processor 704 may include ADU awareness determining circuitry 742 configured for various functions, including, for example, determine, for one or more quality of service (QOS) flows, whether ADU awareness applies based on an application of the at least one of: the ADU detection rules, or the ADU handling rules. In some examples, the ADU awareness determining circuitry 742 may include one or more hardware components that provide the physical structure that performs processes related to determining, for one or more quality of service (QOS) flows, whether ADU awareness applies based on an application of the at least one of: the ADU detection rules, or the ADU handling rules. The ADU awareness determining circuitry 742 may further be configured to execute ADU awareness instructions 752 (e.g., software) stored on the computer-readable medium 706 to implement one or more functions described herein.

In some aspects of the disclosure, the processor 704 may include A5QI assigning circuitry 743 configured for various functions, including, for example, assigning, in response to determining that ADU awareness applies (e.g., by utilizing the ADU awareness determining circuitry 742 described above) at least one ADU 5G QOS flow identifier (A5Q1) to at least one ADU aware QoS flow. The A5QI may be associated with ADU QOS parameters, and the ADU QoS parameters may be included in at least one of: a table of standardized 5G QoS flow Identifier (5Q1) related QoS parameters, or a table of standardized A5QI related QoS parameters. The tables may be stored, for example, in the 5QI related parameters 760 portion of the memory 705, and the A5QI related parameters 761 portion of the memory 705, respectively. In some examples, the A5QI may be associated with ADU QoS parameters, and the ADU QoS parameters may include at least one of: a maximum ADU size, a maximum number of packet data units (PDUs) per ADU, an ADU delay budget, an ADU maximum data burst volume, or an ADU error rate. The ADU QoS parameters may be stored, for example, in the QoS profiles 763 portion of the memory 705. The QoS profiles 763 and/or QoS flow parameters 762 portions of the memory 705 may store, for example, a dedicated ADU QoS profile that includes QoS flow parameters exclusively related to the at least one A5QI, and/or a QoS profile that includes QoS flow parameters related to a 5G QoS flow identifier (5Q1) and the at least one A5QI. In some examples, the A5QI assigning circuitry 743 may include one or more hardware components that provide the physical structure that performs processes related to assigning, in response to determining that ADU awareness applies, at least one A5QI to at least one ADU aware QoS flow. The A5QI assigning circuitry 743 may further be configured to execute A5QI assigning instructions 753 (e.g., software) stored on the computer-readable medium 706 to implement one or more functions described herein.

In some aspects of the disclosure, the processor 704 may include ADU aware QoS flow configuring circuitry 744 configured for various functions, including, for example, configuring a radio access network (RAN) entity with the at least one A5QI and the at least one ADU aware QoS flow. The ADU aware QoS flow configuring circuitry 744 may further be configured to configure a user plane function (UPF) with at least one of: ADU aware filters, or ADU detection rules. In one example, the SMF may send ADU detection rules (PDU Set detection rules) to the UPF via an N4 interface. In some examples, the ADU aware QoS flow configuring circuitry 744 may include one or more hardware components that provide the physical structure that performs processes related to configuring a radio access network (RAN) entity with the at least one A5QI and the at least one ADU aware QoS flow, as well as providing the physical structure to perform processes related to configuring a user plane function (UPF) with at least one of: ADU aware filters, or ADU detection rules. The ADU aware QoS flow configuring circuitry 744 may further be configured to execute the ADU aware QoS flow configuring instructions 754 (e.g., software) stored on the computer-readable medium 706 to implement one or more functions described herein.

In some aspects of the disclosure, for example, when the core network entity 700 is an application function (AF), the processor 704 may include policies and rules negotiating circuitry 745 configured for various functions, including, for example, negotiating at least one of: ADU-based QoS policies, or ADU QOS rules applicable to the session. Various policies and rules may be stored, for example, in the ADU detection rules 765 and/or ADU handling rules 766 portions of the memory 705, for example. In some examples, the policies and rules negotiating circuitry 745 may include one or more hardware components that provide the physical structure that performs processes related to negotiating at least one of: ADU-based QoS policies, or ADU QOS rules applicable to the session. The policies and rules negotiating circuitry 745 may further be configured to execute the policies and rules negotiating instructions 755 (e.g., software) stored on the computer-readable medium 706 to implement one or more functions described herein.

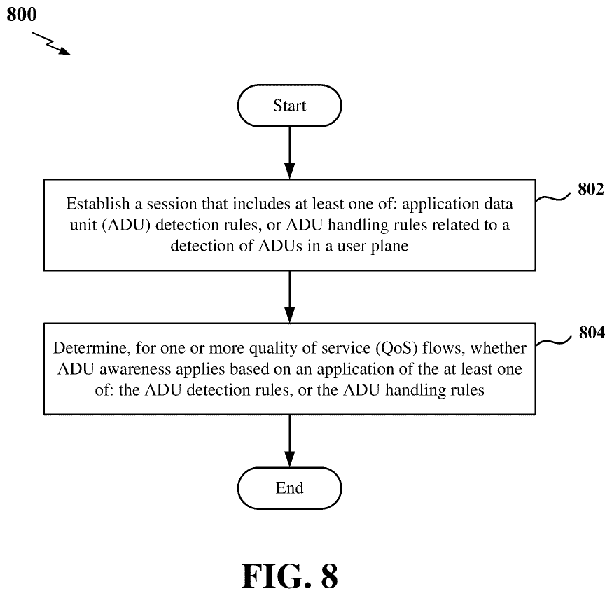

FIG. 8 is a flow chart illustrating an example process 800 (e.g., a method) of wireless communication at a core network entity according to some aspects. As described below, some or all illustrated features may be omitted in a particular implementation within the scope of the present disclosure, and some illustrated features may not be required for implementation of all examples. In some examples, the process 800 may be carried out by an SMF 410 illustrated in FIG. 4. The core network entity may be similar to, for example, the SMF 410 of FIG. 4. In some examples, the process 800 may be carried out by any suitable apparatus or means for carrying out the functions or algorithm described below.

At block 802, the core network entity may establish a session that includes at least one of: application data unit (ADU) detection rules, or ADU handling rules related to a detection of ADUs in a user plane. For example, the session establishment circuitry 741, shown and described above in connection with FIG. 7, may provide a means for establishing a session that includes at least one of: application data unit (ADU) detection rules, or ADU handling rules related to a detection of ADUs in a user plane. According to some aspects, the core network entity may be a session management function (SMF), and the session may be established with a user plane function (UPF) over an interface between the SMF and the UPF. According to one example, the interface may be an N4 interface.

At block 804, the core network entity may determine, for one or more quality of service (QOS) flows, whether ADU awareness applies based on an application of the at least one of: the ADU detection rules, or the ADU handling rules. For example, the ADU awareness determining circuitry 742, shown and described above in connection with FIG. 7, may provide a means for determining, for one or more quality of service (QOS) flows, whether ADU awareness applies based on an application of the at least one of: the ADU detection rules, or the ADU handling rules. In some examples, an ADU may be comprised of a set of Internet Protocol (IP) packets or Ethernet frames (but not a combination of the two) jointly processed by at least one of: an application function, or an application server. The one or more ADUs, each comprising a plurality of PDUs, may be: generated by an application server at substantially a same time, and grouped in at least one burst. In some aspects, the core network entity may obtain policy rules related to ADU-based QoS policies from at least one of: a policy control function (PCF), or a local configuration. According to another aspect, the core network entity may obtain an identity of a user plane function that supports ADU-based QoS policies from a policy control function (PCF).

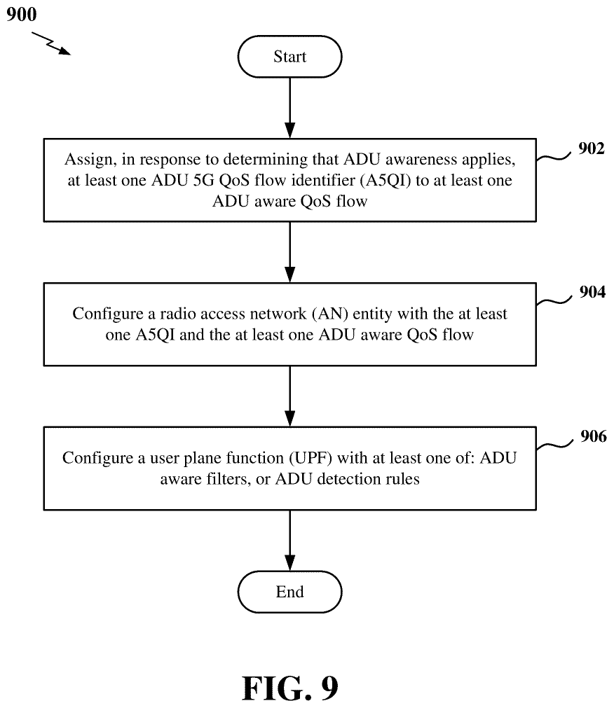

FIG. 9 is a flow chart illustrating an example process 900 (e.g., a method) of wireless communication at a core network entity according to some aspects. As described below, some or all illustrated features may be omitted in a particular implementation within the scope of the present disclosure, and some illustrated features may not be required for implementation of all examples. In some examples, the process 900 may be carried out by the AMF 408 illustrated in FIG. 4. The core network entity may be similar to, for example, the AMF 408 of FIG. 4. In some examples, the process 900 may be carried out by any suitable apparatus or means for carrying out the functions or algorithm described below.

At block 902, the core network entity may assign, in response to determining that ADU awareness applies, at least one ADU 5G QOS flow identifier (A5Q1) to at least one ADU aware QoS flow. For example, the A5QI assigning circuitry 743, shown and described above in connection with FIG. 7, may provide a means for assigning, in response to determining that ADU awareness applies, at least one ADU 5G QOS flow identifier (A5QI) to at least one ADU aware QoS flow. According to some aspects, the A5QI may be associated with ADU QoS parameters, and the ADU QoS parameters may be included in at least one of: a table of standardized 5G QoS flow Identifier (5Q1) related QoS parameters, or a table of standardized A5QI related QoS parameters. In some examples, the A5QI may be associated with ADU QoS parameters, and the ADU QoS parameters may include at least one of: a maximum ADU size, a maximum number of packet data units (PDUs) per ADU, an ADU delay budget, an ADU maximum data burst volume, or an ADU error rate. In another example, parameters related to the at least one ADU aware QoS flow may be provided in at least one of: a dedicated ADU QoS profile that includes QoS flow parameters exclusively related to the at least one A5QI, or a QoS profile that includes QoS flow parameters related to a 5G QoS flow identifier (5Q1) and the at least one A5QI.

At block 904, the core network entity may configure a radio access network (RAN) entity with the at least one A5QI and the at least one ADU aware QoS flow. For example, the ADU aware QoS flow configuring circuitry 744, shown and described above in connection with FIG. 7, may provide a means for configuring a radio access network (RAN) entity with the at least one A5QI and the at least one ADU aware QoS flow.

At block 906, the core network entity may configure a user plane function (UPF) with at least one of: ADU aware filters, or ADU detection rules. For example, the ADU aware QoS flow configuring circuitry 744, shown and described above in connection with FIG. 7, may provide a means for configuring a user plane function (UPF) with at least one of: ADU aware filters, or ADU detection rules. In some examples, the core network entity may configure ADU aware uplink filters to a user equipment during at least one of: packet data unit (PDU) session establishment, or PDU session modification.

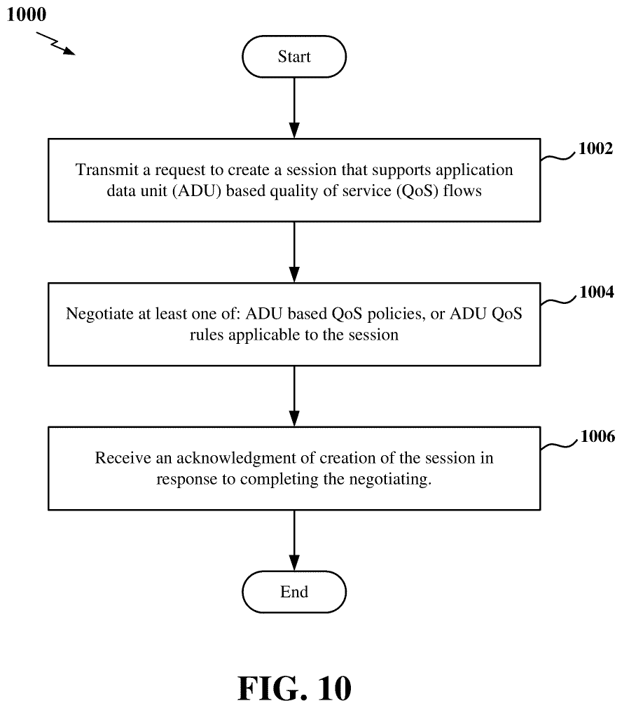

FIG. 10 is a flow chart illustrating an example process 1000 (e.g., a method) of wireless communication at core network entity according to some aspects. As described below, some or all illustrated features may be omitted in a particular implementation within the scope of the present disclosure, and some illustrated features may not be required for implementation of all examples. In some examples, the process 1000 may be carried out by the core network entity 700 (e.g., an application function (AF)) illustrated in FIG. 7. The core network entity 700 may be similar to, for example, the XR AF 418 of FIG. 4. In some examples, the process 1000 may be carried out by any suitable apparatus or means for carrying out the functions or algorithm described below.

At block 1002, the core network entity may transmit a request to create a session that supports application data unit (ADU) based quality of service (QOS) flows. For example, the session establishment circuitry 741, shown and described above in connection with FIG. 7, may provide a means for transmitting a request to create a session that supports application data unit (ADU) based quality of service (QOS) flows. According to some aspects, the core network entity may be an application function (AF) and the session may be an AF session. In some examples, the request to create the session may be transmitted to a network exposure function (NEF) and the acknowledgment may be received from the NEF if the core network entity is not a trusted core network entity, or the request to create the session may be transmitted to a policy control function (PCF) and the acknowledgment may be received from the PCF if the core network entity is a trusted core network entity. According to some aspects, the PCF may create PCC rules for ADU-based QoS (PDU Set based QoS).

At block 1004, the core network entity may negotiate at least one of: ADU-based QoS policies, or ADU QOS rules applicable to the session. By way of example, when the core network entity is an AF, the AF may negotiate capability support of 5GS. For example, the policies and rules negotiating circuitry 745, shown and described above in connection with FIG. 7, may provide a means for negotiating at least one of: ADU-based QoS policies, or ADU QOS rules applicable to the session.

At block 1006, the core network entity may receive an acknowledgment of creation of the session in response to completing the negotiating. For example, the communication and processing circuitry 740 and the policies and rules negotiating circuitry 745, in combination with the interface 710 shown and described above in connection with FIG. 7, may provide a means for receiving an acknowledgment of creation of the session in response to completing the negotiating.

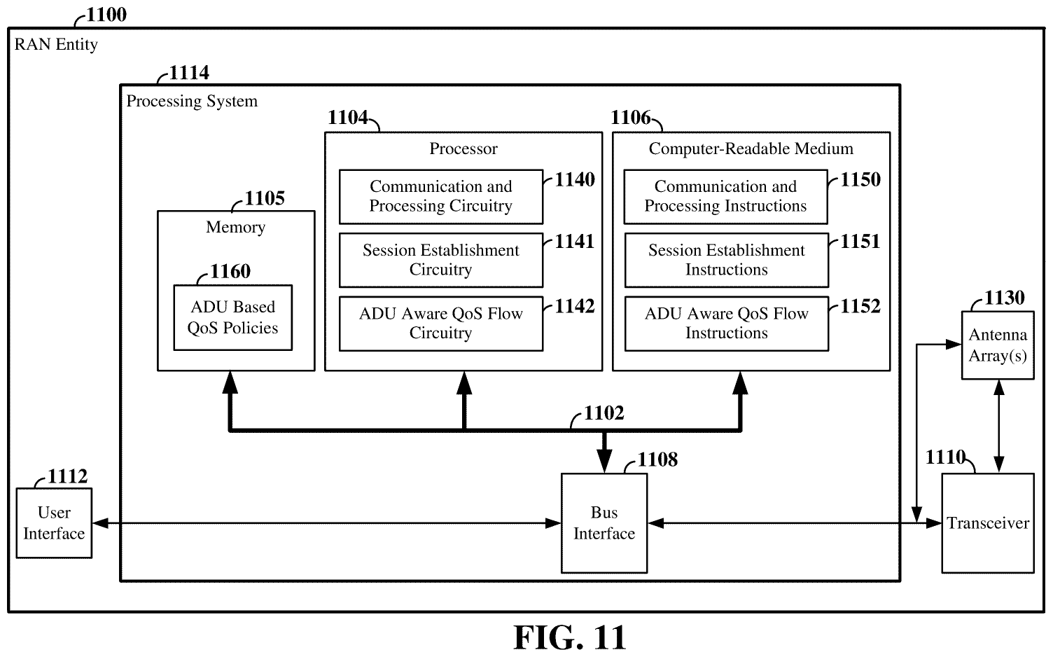

FIG. 11 is a block diagram illustrating an example of a hardware implementation of a RAN entity 1100 employing a processing system according to some aspects. For example, the RAN entity 1100 may correspond to any of the base stations (e.g., gNBs), or other scheduling entities illustrated in any one or more of FIGS. 1, 2, 4, and/or 6.

In accordance with various aspects of the disclosure, an element, or any portion of an element, or any combination of elements may be implemented with a processing system 1114 that includes one or more processors 1104. The processing system 1114 may be substantially the same as the processing system 714 illustrated in FIG. 7, including a bus interface 1108, a bus 1102, memory 1105, a processor 1104, and a computer-readable medium 1106. Furthermore, the RAN entity 1100 may include an optional user interface 1112 and a transceiver 1110. In addition, the RAN entity may include an antenna/antenna array(s) 1130, which may be operationally coupled to the transceiver 1110 and the bus interface 1108. In some examples, the transceiver 1110 and/or antenna/antenna array(s) 1130 may include a phase-shifter (not shown) for digital and/or analog beamforming via one or more of the antenna/antenna array(s) 1130. The processor 1104, as utilized in a RAN entity 1100, may be used to implement any one or more of the processes described below.

In some aspects of the disclosure, the processor 1104 may include circuitry configured for various functions. For example, the processor 1104 may include communication and processing circuitry 1140, configured to communicate with user equipment and various core network entities. The communication and processing circuitry 1140 of FIG. 11 may be substantially similar to the communication and processing circuitry 740 of FIG. 7; accordingly, the description will not be repeated for the sake of brevity.

In some aspects of the disclosure, the processor 1104 may include session establishment circuitry 1141 configured for various functions, including, for example, receiving a session request, accepting establishment of the session, and transmitting a session response. In some examples, the session establishment circuitry 1141 may include one or more hardware components that provide the physical structure that performs processes related to receiving a session request, accepting establishment of the session, and transmitting a session response. The session establishment circuitry 1141 may further be configured to execute session establishment instructions 1151 (e.g., software) stored on the computer-readable medium 706 to implement one or more functions described herein.

In some aspects of the disclosure, the processor 1104 may include ADU aware QoS flow circuitry 1142 configured for various functions, including, for example, conveying, during a session, one or more application data units (ADUs) to a user equipment via a user plane in compliance with ADU-based QoS policies associated with at least one ADU aware QoS flow. The ADU-based QoS policies may be stored, for example, in an ADU-based QoS policies 1160 portion of the memory 1105. According to some examples, the one or more ADUs, may each include a plurality of PDUs, may be generated by an application server at substantially a same time, and may be grouped in at least one burst. In some aspects, the at least one burst may correspond to at least one of: a video frame, or slices of the video frame. According to some examples, the session request and the session response may be exchanged with a session management function (SMF) over an N2 interface via an access and mobility function (AMF). In some examples, the ADU aware QoS flow circuitry 1142 may include one or more hardware components that provide the physical structure that performs processes related to conveying, during a session, one or more application data units (ADUs) to a user equipment via a user plane in compliance with ADU-based QoS policies associated with at least one ADU aware QoS flow. The ADU aware QoS flow circuitry 1142 may further be configured to execute ADU Aware QoS flow instructions 1152 (e.g., software) stored on the computer-readable medium 1106 to implement one or more functions described herein.

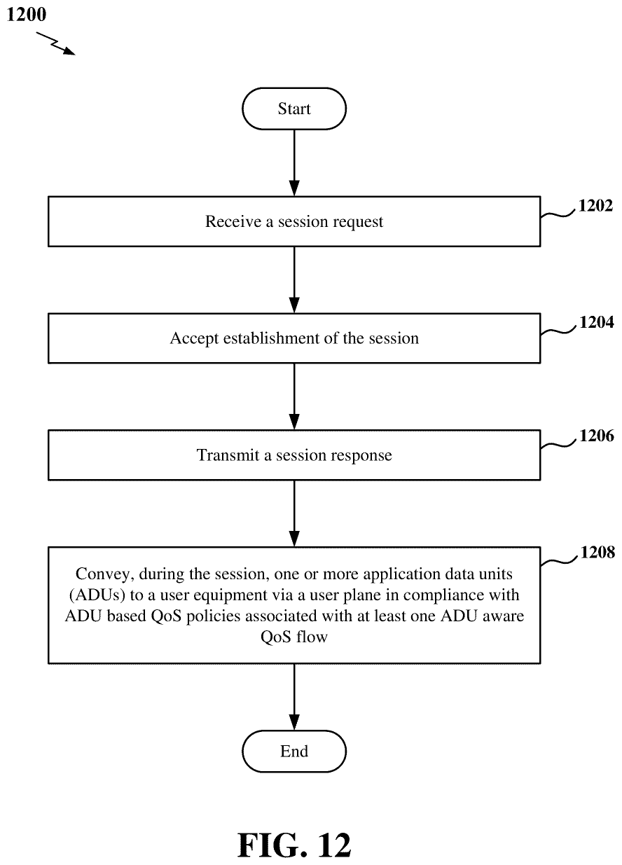

FIG. 12 is a flow chart illustrating an example process 1200 (e.g., a method) of wireless communication at RAN entity according to some aspects. As described below, some or all illustrated features may be omitted in a particular implementation within the scope of the present disclosure, and some illustrated features may not be required for implementation of all examples. In some examples, the process 1200 may be carried out by the RAN entity 1100 illustrated in FIG. 11. The RAN entity 1100 may be similar to, for example, to any RAN entity in any of FIGS. 1, 2, 4, and/or 6. In some examples, the process 1200 may be carried out by any suitable apparatus or means for carrying out the functions or algorithm described below.

At block 1202, the RAN entity may receive a session request. At block 1204, the RAN entity may accept establishment of the session. At block 1206, the RAN entity may transmit a session response. For example, the session establishment circuitry 1141, in combination with the transceiver 1110 and antenna array(s) 1130, shown and described above in connection with FIG. 11, may provide a means for receiving a session request, accepting establishment of the session, and/or transmitting a session response. According to some aspects, the session may be a PDU session.

At block 1208, the RAN entity may convey, during the session, one or more application data units (ADUs) to a user equipment via a user plane in compliance with ADU-based QoS policies associated with at least one ADU aware QoS flow. For example, the ADU aware QoS flow circuitry 1142, in combination with the transceiver 1110 and antenna array(s) 1130, shown and described above in connection with FIG. 11, may provide a means for conveying, during the session, one or more application data units (ADUs) to a user equipment via a user plane in compliance with ADU-based QoS policies associated with at least one ADU aware QoS flow. According to some aspects, the ADU-based QoS policies may be stored in the ADU-based QoS policies 1160 portion of the memory 1105 of the RAN entity 1100 as shown and described in connection with FIG. 11.

Several aspects of a wireless communication network have been presented with reference to an example implementation. As those skilled in the art will readily appreciate, various aspects described throughout this disclosure may be extended to other telecommunication systems, network architectures and communication standards.
Aspect 1: A core network entity for wireless communication, comprising: a memory, and a processor coupled to the memory, the processor and the memory being configured to: establish a session that includes at least one of: application data unit (ADU) detection rules, or ADU handling rules related to a detection of ADUs in a user plane, and determine, for one or more quality of service (QOS) flows, whether ADU awareness applies based on an application of the at least one of: the ADU detection rules, or the ADU handling rules.
Aspect 2: The core network entity of aspect 1, wherein the processor and the memory are further configured to: assign, in response to determining that ADU awareness applies, at least one ADU 5G QOS flow identifier (A5Q1) to at least one ADU aware QoS flow, and configure a radio access network (RAN) entity with the at least one A5QI and the at least one ADU aware QoS flow.
Aspect 3: The core network entity of aspect 2, wherein the A5QI is associated with ADU QOS parameters, and the ADU QOS parameters are included in at least one of: a table of standardized 5G QoS flow Identifier (5Q1) related QoS parameters, or a table of standardized A5QI related QoS parameters.
Aspect 4: The core network entity of aspect 1 or 2, wherein the A5QI is associated with ADU QoS parameters, and the ADU QoS parameters include at least one of: a maximum ADU size, a maximum number of packet data units (PDUs) per ADU, an ADU delay budget, an ADU maximum data burst volume, or an ADU error rate.
Aspect 5: The core network entity of any of aspects 1 through 4, wherein parameters related to the at least one ADU aware QoS flow are provided in at least one of: a dedicated ADU QoS profile that includes QoS flow parameters exclusively related to the at least one A5QI, or a QoS profile that includes QoS flow parameters related to a 5G QoS flow identifier (5Q1) and the at least one A5QI.
Aspect 6: The core network entity of any of aspects 1 through 5, wherein the processor and the memory are further configured to: configure a user plane function (UPF) with at least one of: ADU aware filters, or the ADU detection rules.
Aspect 7: The core network entity of any of aspects 1 through 6, wherein the core network entity is a session management function (SMF), and the session is established with a user plane function (UPF) over an interface between the SMF and the UPF.
Aspect 8: The core network entity of aspect 7, wherein the interface is an N4 interface.
Aspect 9: The core network entity of any of aspects 1 through 8, wherein an ADU is comprised of a set of Internet Protocol (IP) packets or Ethernet frames jointly processed by at least one of: an application function, or an application server.
Aspect 10: The core network entity of any of aspects 1 through 9, wherein one or more ADUs, each comprising a plurality of PDUs, are: generated by an application server at substantially a same time, and grouped in at least one burst.
Aspect 11: The core network entity of any of aspects 1 through 10, wherein the processor and the memory are further configured to: configure ADU aware uplink filters to a user equipment during at least one of: packet data unit (PDU) session establishment, or PDU session modification.
Aspect 12: The core network entity of any of aspects 1 through 11, wherein the processor and the memory are further configured to: obtain policy rules related to ADU-based QoS policies from at least one of: a policy control function (PCF), or a local configuration.
Aspect 13: The core network entity of any of aspects 1 through 12, wherein the processor and the memory are further configured to: obtain an identity of a user plane function that supports ADU-based QoS policies from a policy control function (PCF).
Aspect 14: A method at a core network entity, comprising: establishing a session that includes at least one of: application data unit (ADU) detection rules, or ADU handling rules related to a detection of ADUs in a user plane, and determining, for one or more quality of service (QOS) flows, whether ADU awareness applies based on an application of the at least one of: the ADU detection rules, or the ADU handling rules.
Aspect 15: The method of aspect 14, further comprising: assigning, in response to determining that ADU awareness applies, at least one ADU 5G QoS flow identifier (A5QI) to at least one ADU aware QoS flow, and configuring a radio access network (RAN) entity with the at least one A5QI and the at least one ADU aware QoS flow.
Aspect 16: The method of aspect 14 or 15, wherein the A5QI is associated with ADU QOS parameters, and the ADU QoS parameters are included in at least one of: a table of standardized 5G QoS flow Identifier (5Q1) related QoS parameters, or a table of standardized A5QI related QoS parameters.
Aspect 17: The method of any of aspects 14 through 16, wherein the A5QI is associated with ADU QOS parameters, and the ADU QoS parameters include at least one of: a maximum ADU size, a maximum number of packet data units (PDUs) per ADU, an ADU delay budget, an ADU maximum data burst volume, or an ADU error rate.
Aspect 18: The method of any of aspects 14 through 17, wherein parameters related to the at least one ADU aware QoS flow are provided in at least one of: a dedicated ADU QoS profile that includes QoS flow parameters exclusively related to the at least one A5QI, or a QoS profile that includes QoS flow parameters related to a 5G QoS flow identifier (5QI) and the at least one A5QI.
Aspect 19: The method of any of aspects 14 through 18, further comprising: configuring a user plane function (UPF) with at least one of: ADU aware filters, or the ADU detection rules.
Aspect 20: The method of any of aspects 14 through 19, wherein the core network entity is a session management function (SMF), and the session is established with a user plane function (UPF) over an interface between the SMF and the UPF.
Aspect 21: The method of any of aspects 14 through 20, wherein an ADU is comprised of a set of Internet Protocol (IP) packets or Ethernet frames jointly processed by at least one of: an application function, or an application server.
Aspect 22: The method of any of aspects 14 through 21, wherein one or more ADUs, each comprising a plurality of PDUs, are: generated by an application server at substantially a same time, and grouped in at least one burst.
Aspect 23: The method of any of aspects 14 through 22, further comprising: configuring ADU aware uplink filters to a user equipment during at least one of: packet data unit (PDU) session establishment, or PDU session modification.
Aspect 24: The method of any of aspects 14 through 23, further comprising: obtaining policy rules related to ADU-based QoS policies from at least one of: a policy control function (PCF), or a local configuration.
Aspect 25: The method of any of aspects 14 through 24, further comprising: obtaining an identity of a user plane function that supports ADU-based QoS policies from a policy control function (PCF).
Aspect 26: A core network entity for wireless communication, comprising: a memory, and a processor coupled to the memory, the processor and the memory being configured to: transmit a request to create a session that supports application data unit (ADU) based quality of service (QOS) flows, negotiate at least one of: ADU-based QoS policies, or ADU QOS rules applicable to the session, and receive an acknowledgment of creation of the session in response to completing the negotiating.
Aspect 27: The core network entity of aspect 26, wherein the core network entity is an application function (AF), and the session is an AF session.
Aspect 28: The core network entity of aspect 25 or 26, wherein the request to create the session is transmitted to a network exposure function (NEF) and the acknowledgment is received from the NEF if the core network entity is not a trusted core network entity, or the request to create the session is transmitted to a policy control function (PCF) and the acknowledgment is received from the PCF if the core network entity is a trusted core network entity.
Aspect 29: A method at a core network entity, comprising: transmitting a request to create a session that supports application data unit (ADU) based quality of service (QOS) flows, negotiating at least one of: ADU-based QoS policies, or ADU QoS rules applicable to the session, and receiving an acknowledgment of creation of the session in response to completing the negotiating.
Aspect 30: The method of aspect 29, wherein the core network entity is an application function (AF), and the session is an AF session.
Aspect 31: The method of aspect 29 or 30, wherein the request to create the session is transmitted to a network exposure function (NEF) and the acknowledgment is received from the NEF if the core network entity is not a trusted core network entity, or the request to create the session is transmitted to a policy control function (PCF) and the acknowledgment is received from the PCF if the core network entity is a trusted core network entity.
Aspect 32: A method at a radio access network (RAN) entity, comprising: receiving a session request, accepting establishment of the session, transmitting a session response, and conveying, during the session, one or more application data units (ADUs) to a user equipment via a user plane in compliance with ADU-based QoS policies associated with at least one ADU aware QoS flow.
Aspect 33: The method of aspect 32, wherein the one or more ADUs, each comprising a plurality of PDUs, are: generated by an application server at substantially a same time, and grouped in at least one burst.
Aspect 34: The method of aspect 33, wherein the at least one burst corresponds to at least one of: a video frame, or slices of the video frame.
Aspect 35: The method of any of aspects 32 through 34, wherein the session request and the session response are exchanged with a session management function (SMF) over an N2 interface via an access and mobility function (AMF).
Aspect 36: A core network entity configured for wireless communication comprising at least one means for performing a method of any one of aspects 14 through 25 or 29 through 31.
Aspect 37: A non-transitory computer-readable medium storing computer-executable code, comprising code for causing a core network entity to perform a method of any one of aspects 14 through 25 or 29 through 31.
Aspect 38: A radio access network entity configured for wireless communication comprising a processor, and a memory coupled to the processor, the processor and memory configured to perform a method of any one of aspects 32 through 35.
Aspect 39: A radio access network entity configured for wireless communication comprising at least one means for performing a method of any one of aspects 32 through 35.
Aspect 40: A non-transitory computer-readable medium storing computer-executable code, comprising code for causing a radio access network entity to perform a method of any one of aspects 32 through 35.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-12 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in any one or more of FIGS. 1-12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. similarly, the construct “a and/or b” is intended to cover a; b; and a and b. The construct A and/or B is intended to cover A, B, and A and B. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A core network entity for wireless communication, comprising:
a memory; and
a processor coupled to the memory, the processor and the memory being configured to:
establish a session that includes at least one of: application data unit (ADU) detection rules, or ADU handling rules related to a detection of ADUs in a user plane; and
determine, for one or more quality of service (QOS) flows, whether ADU awareness applies based on an application of the at least one of: the ADU detection rules, or the ADU handling rules.

2. The core network entity of claim 1, wherein the processor and the memory are further configured to:
assign, in response to determining that ADU awareness applies, at least one ADU 5G QoS flow identifier (A5QI) to at least one ADU aware QoS flow; and
configure a radio access network (RAN) entity with the at least one A5QI and the at least one ADU aware QoS flow.

3. The core network entity of claim 2, wherein the A5QI is associated with ADU QoS parameters, and the ADU QoS parameters are included in at least one of: a table of standardized 5G QoS flow Identifier (5Q1) related QoS parameters, or a table of standardized A5QI related QoS parameters.

4. The core network entity of claim 2, wherein the A5QI is associated with ADU QoS parameters, and the ADU QoS parameters include at least one of: a maximum ADU size, a maximum number of packet data units (PDUs) per ADU, an ADU delay budget, an ADU maximum data burst volume, or an ADU error rate.

5. The core network entity of claim 2, wherein parameters related to the at least one ADU aware QoS flow are provided in at least one of:
a dedicated ADU QoS profile that includes QoS flow parameters exclusively related to the at least one A5QI, or
a QoS profile that includes QoS flow parameters related to a 5G QoS flow identifier (5Q1) and the at least one A5QI.

6. The core network entity of claim 1, wherein the processor and the memory are further configured to:
configure a user plane function (UPF) with at least one of: ADU aware filters, or the ADU detection rules.

7. The core network entity of claim 1, wherein the core network entity is a session management function (SMF), and the session is established with a user plane function (UPF) over an interface between the SMF and the UPF.

8. The core network entity of claim 1, wherein an ADU is comprised of a set of Internet Protocol (IP) packets or Ethernet frames jointly processed by at least one of: an application function, or an application server.

9. The core network entity of claim 1, wherein one or more ADUs, each comprising a plurality of PDUs, are:
generated by an application server at substantially a same time; and
grouped in at least one burst.

10. The core network entity of claim 1, wherein the processor and the memory are further configured to:
configure ADU aware uplink filters to a user equipment during at least one of: packet data unit (PDU) session establishment, or PDU session modification.

11. The core network entity of claim 1, wherein the processor and the memory are further configured to:
obtain policy rules related to ADU-based QoS policies from at least one of:
a policy control function (PCF), or
a local configuration.

12. The core network entity of claim 1, wherein the processor and the memory are further configured to:
obtain an identity of a user plane function that supports ADU-based QoS policies from a policy control function (PCF).

13. A method at a core network entity, comprising:
establishing a session that includes at least one of: application data unit (ADU) detection rules, or ADU handling rules related to a detection of ADUs in a user plane; and
determining, for one or more quality of service (QOS) flows, whether ADU awareness applies based on an application of the at least one of: the ADU detection rules, or the ADU handling rules.

14. The method of claim 13, further comprising:
assigning, in response to determining that ADU awareness applies, at least one ADU 5G QoS flow identifier (A5QI) to at least one ADU aware QoS flow; and
configuring a radio access network (RAN) entity with the at least one A5QI and the at least one ADU aware QoS flow.

15. The method of claim 14, wherein the A5QI is associated with ADU QoS parameters, and the ADU QoS parameters are included in at least one of: a table of standardized 5G QoS flow Identifier (5Q1) related QoS parameters, or a table of standardized A5QI related QoS parameters.

16. The method of claim 14, wherein the A5QI is associated with ADU QoS parameters, and the ADU QoS parameters include at least one of: a maximum ADU size, a maximum number of packet data units (PDUs) per ADU, an ADU delay budget, an ADU maximum data burst volume, or an ADU error rate.

17. The method of claim 14, wherein parameters related to the at least one ADU aware QoS flow are provided in at least one of:
a dedicated ADU QoS profile that includes QoS flow parameters exclusively related to the at least one A5QI, or
a QoS profile that includes QoS flow parameters related to a 5G QoS flow identifier (5Q1) and the at least one A5QI.

18. The method of claim 13, further comprising:
configuring a user plane function (UPF) with at least one of: ADU aware filters, or the ADU detection rules.

19. The method of claim 13, wherein the core network entity is a session management function (SMF), and the session is established with a user plane function (UPF) over an interface between the SMF and the UPF.

20. The method of claim 13, wherein an ADU is comprised of a set of Internet Protocol (IP) packets or Ethernet frames jointly processed by at least one of: an application function, or an application server.

21. The method of claim 13, wherein one or more ADUs, each comprising a plurality of PDUs, are:
generated by an application server at substantially a same time; and
grouped in at least one burst.

22. The method of claim 13, further comprising:
configuring ADU aware uplink filters to a user equipment during at least one of: packet data unit (PDU) session establishment, or PDU session modification.

23. The method of claim 13, further comprising:
obtaining policy rules related to ADU-based QoS policies from at least one of:
a policy control function (PCF), or
a local configuration.

24. The method of claim 13, further comprising:
obtaining an identity of a user plane function that supports ADU-based QoS policies from a policy control function (PCF).

25. A core network entity for wireless communication, comprising:
a memory; and
a processor coupled to the memory, the processor and the memory being configured to:
transmit a request to create a session that supports application data unit (ADU) based quality of service (QOS) flows,
negotiate at least one of: ADU-based QoS policies, or ADU QoS rules applicable to the session, and
receive an acknowledgment of creation of the session in response to completing the negotiating.

26. The core network entity of claim 25, wherein the core network entity is an application function (AF), and the session is an AF session.

27. The core network entity of claim 25, wherein the request to create the session is transmitted to a network exposure function (NEF) and the acknowledgment is received from the NEF if the core network entity is not a trusted core network entity, or the request to create the session is transmitted to a policy control function (PCF) and the acknowledgment is received from the PCF if the core network entity is a trusted core network entity.

28. A method at a core network entity, comprising:
transmitting a request to create a session that supports application data unit (ADU) based quality of service (QOS) flows;
negotiating at least one of: ADU-based QoS policies, or ADU QOS rules applicable to the session; and
receiving an acknowledgment of creation of the session in response to completing the negotiating.

29. The method of claim 28, wherein the core network entity is an application function (AF), and the session is an AF session.

30. The method of claim 28, wherein the request to create the session is transmitted to a network exposure function (NEF) and the acknowledgment is received from the NEF if the core network entity is not a trusted core network entity, or the request to create the session is transmitted to a policy control function (PCF) and the acknowledgment is received from the PCF if the core network entity is a trusted core network entity.
